(19) United States
(12) Patent Application Publication
(10) Pub. No.: US 2003/0217884 A1
(43) Pub. Date: Nov. 27, 2003

(54) Four-wheeled all terrain vehicle

(75) Inventor: Yuichi Kawamoto, Akashi-shi (JP)

Correspondence Address: OLIFF & BERRIDGE, PLC, P.O. BOX 19928, ALEXANDRIA, VA, 22320, US

(73) Assignee: KAWASAKI JUKOGYO KABUSHIKI KAISHA, Kobe-Shi (JP)

(21) Appl. No.: 10/424,755

(22) Filed: Apr. 29, 2003

(30) Foreign Application Priority Data
May 24, 2002 (JP) 2002-150283

(51) Int. Cl. B60K 5/00

(52) U.S. Cl. 180/292

(57) ABSTRACT

A four-wheeled all terrain vehicle includes a straddle-type seat 10 and a V-type engine 21. The V-type engine 21 has a crank case 24 and a transmission mechanism, with a center line E of a V-bank being inclined forward. A body frame 2 has an engine-receiving space between front wheels 2 and rear wheels 5, which is of substantially a parallelogram shape when viewed from a lateral side of the body frame. The V-type engine 21 is installed in the engine-receiving space. A carburetor 9 is disposed in or above the V-bank. A rear suspension 3 is held by the body frame at a rear side thereof.

### FIELD OF THE INVENTION

The present invention relates to a four-wheeled all terrain vehicle which includes a straddle-type seat and a V-type engine.

### BACKGROUND OF THE INVENTION

There is an example of a conventional four-wheeled all terrain vehicle of this type (Japanese Patent Laid-Open Publication No. 172083/1989). In this example, an engine mounted on the conventional four-wheeled vehicle is a V-type engine, with a center line of a V-bank, formed between front and rear cylinders, being vertical. A body frame forms an engine-receiving space between front and rear wheels. The space is of an approximately parallelogram shape inclined forward when viewed from a lateral side. The V-type engine is installed in the engine-receiving space of a parallelogram shape, with an engine body thereof projecting upward from the engine-receiving space. The conventional four-wheeled vehicle is not equipped with a rear suspension.

In a four-wheeled all terrain vehicle, an engine is installed from a lateral side of the body frame. As compared to an inline engine, a V-type engine has a larger body when viewed from a lateral side. In the constitution in which the body of the engine is projected upward from the engine-receiving space, as described in the conventional art of the above publication, it takes a long time to install the engine to the engine-receiving space. It also takes a long time to maintain the engine from a lateral side, which is different from the case of maintaining a two-wheeled motorcycle.

### SUMMARY OF THE INVENTION

The present invention is made in view of these disadvantages, and it is an object of the present invention to provide a four-wheeled all terrain vehicle in which a V-type engine mounted on a body frame, a carburetor or a fuel injection system, a rear suspension, an air cleaner box, and a fuel tank are formed and positioned such that they are arranged in a compact configuration, with a support rigidity of the rear suspension and a weight balance of a body being retained.

A four-wheeled all terrain vehicle according to the present invention comprises: a body frame forming an engine-receiving space of a parallelogram shape inclined forward when viewed from a lateral side; a V-type engine including an engine body and a carburetor or a fuel injection system, the engine body comprising a front cylinder inclined forward, a rear cylinder inclined rearward, and a crank case having a transmission chamber in a rear portion thereof for containing a transmission mechanism, the engine body being formed such that a center line of a V-bank formed between the front cylinder and the rear cylinder is inclined forward, the carburetor or the fuel injection system being disposed in or above the V-bank of the engine body; front wheels and rear wheels which are suspended by the body frame; a straddle-type seat held by an upper portion of the body frame; and a rear suspension for supporting rear wheels, an upper end of the rear suspension being held at a rear upper corner of the engine receiving space of the body frame; wherein the engine body of the V-type engine is installed in the engine-receiving space of the body frame substantially without the engine body protruding therefrom.

As a result, the objects mounted on the body frame are arranged in a compact configuration and an attachment or detachment of the engine is readily made from a lateral side of a body frame. Thus, the engine can be easily attached and maintained. Further, a compact configuration is attained, with a support rigidity of the rear suspension being retained.

In the four-wheeled all terrain vehicle according to the present invention, an air cleaner box of the engine may be disposed above the carburetor or the fuel injection system, and a fuel tank of the engine may be disposed on a rear side of the rear suspension and a lower side of the seat.

As a result, a traveling wind from a front side can be efficiently taken in by a short intake duct.

In the four-wheeled all terrain vehicle according to the present invention, a fuel tank of the engine may be disposed above the carburetor or the fuel injection system.

In the four-wheeled all terrain vehicle according to the present invention, a steering shaft of the vehicle may be disposed on a front side of the body frame, and the air cleaner box may be disposed in a front fender of the vehicle disposed on a front side of the steering shaft.

As a result, a weight balance of the vehicle can be less influenced by an increase and decrease of a fuel, and an air-intake performance can be improved.

In the four-wheeled all terrain vehicle according to the present invention, a battery of the vehicle may be disposed on a rear side of the rear suspension.

As a result, the battery can be protected from the outside because of the arrangement of the seat.

In the four-wheeled all terrain vehicle according to the present invention, an air cleaner box of the engine may be disposed on a rear side of the rear suspension and a lower side of the seat.

As a result, a weight balance of the vehicle can be less influenced by an increase and decrease of a fuel, and mud or water can be prevented from entering the air cleaner box because of the arrangement of the seat.

In the four-wheeled all terrain vehicle according to the present invention, a steering shaft of the vehicle may be disposed on a front side of the body frame, and a radiator of the engine may be disposed between the front cylinder of the V-type engine and the steering shaft.

As a result, the vehicle can be configured in a compact manner.

In the four-wheeled all terrain vehicle according to the present invention, a steering shaft of the vehicle may be disposed on a front side of the body frame, and a radiator of the vehicle may be disposed in a front fender of the vehicle disposed on a front side of the steering shaft.

As a result, a cooling effect of the radiator can be improved.

The above and further objects and features of the present invention will be more fully apparent from the following detailed description with accompanying drawings.

### BRIEF DESCRIPTION OF THE DRAWINGS

FIG. 1 is a left side cross-sectional view showing a first embodiment of a four-wheeled all terrain vehicle according to the present invention;

FIG. 2 is an enlarged partially cut-away cross-sectional view of a V-type engine mounted on the four-wheeled all terrain vehicle shown in FIG. 1;

FIG. 3 is an expanded view of FIG. 2 taken along III-III line;

FIG. 4 is an expanded view of FIG. 2 taken along IV-IV line;

FIG. 5 is a left side cross-sectional view showing a second embodiment of a four-wheeled all terrain vehicle according to the present invention;

FIG. 6 is a left side cross-sectional view showing a third embodiment of a four-wheeled all terrain vehicle according to the present invention;

FIG. 7 is a left side cross-sectional view showing a fourth embodiment of a four-wheeled all terrain vehicle according to the present invention; and

FIG. 8 is a left side cross-sectional view showing a fifth embodiment of a four-wheeled all terrain vehicle according to the present invention.

### PREFERRED EMBODIMENTS OF THE INVENTION

First Embodiment

[Structure of V-Type Engine]

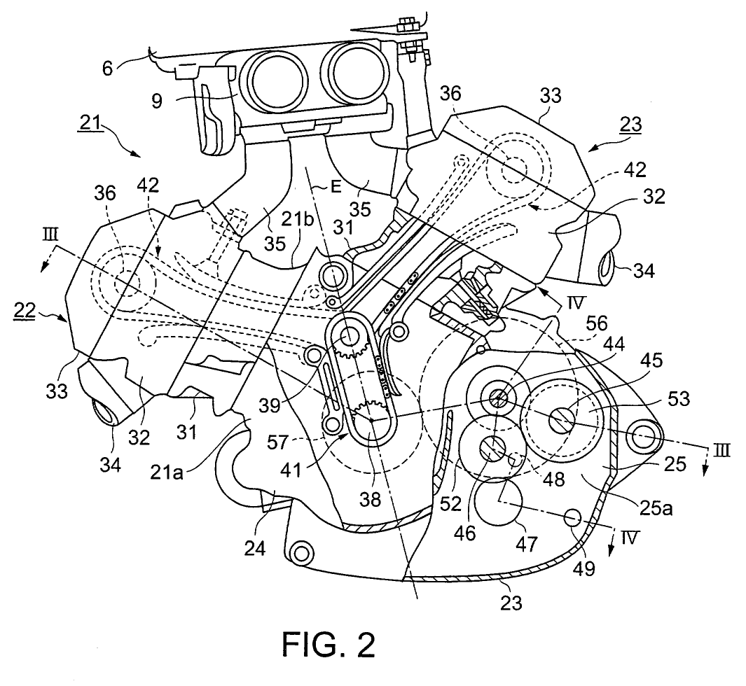

FIG. 2 is a partially cut-away left side cross-sectional view of a 2-cylinder V-type engine 21 mounted on a four-wheeled all terrain vehicle according to the present invention. The V-type engine 21 includes an engine body 21a having a forward-inclined front cylinder 22, a backward-inclined rear cylinder 23, and a crank case 24 below the cylinders 22 and 23. The front cylinder 22 and the rear cylinder 23 are held on the crank case 24 respectively. A transmission chamber (mission case part) 25 is integrally formed with a rear portion of the crank case 24. A V-bank 21b formed between both the cylinders 22 and 23 has a center line E inclined forward so that the front cylinder 22 is positioned lower than the rear cylinder 23.

Each of the cylinders 22 and 23 has a cylinder portion 31, a cylinder head 32, and a head cover 33 which are sequentially fastened to the crank case 24. A cam shaft 36 for driving engine valves is disposed above each cylinder head 32. A cam driving intermediate shaft 39 is disposed on an upper side of a crank shaft 38 along the V-bank center line E. The cam driving intermediate shaft 39 is connected to the crank shaft 38 through a cam driving intermediate chain mechanism 41, and is also connected to each camshaft 36 through a cam driving chain mechanism 42.

Exhaust pipes 34 are respectively connected to a front lower surface of the cylinder head 32 of the front cylinder 22, and to a rear lower surface of the cylinder head 32 of the rear cylinder 23. Intake pipes 35 are respectively connected to a rear upper surface of the cylinder head 32 of the front cylinder 22, and to a front upper surface of the cylinder head 32 of the rear cylinder 23. Both the intake pipes 35 are connected to a lower exit of a carburetor 9 disposed on an upper side of the V-bank 21b.

In the transmission chamber 25, there are disposed a transmission input shaft 44, a transmission output shaft 45, a reverse idling gear shaft 46, a change drum 47, a shift rod 48 and a change shaft 49.

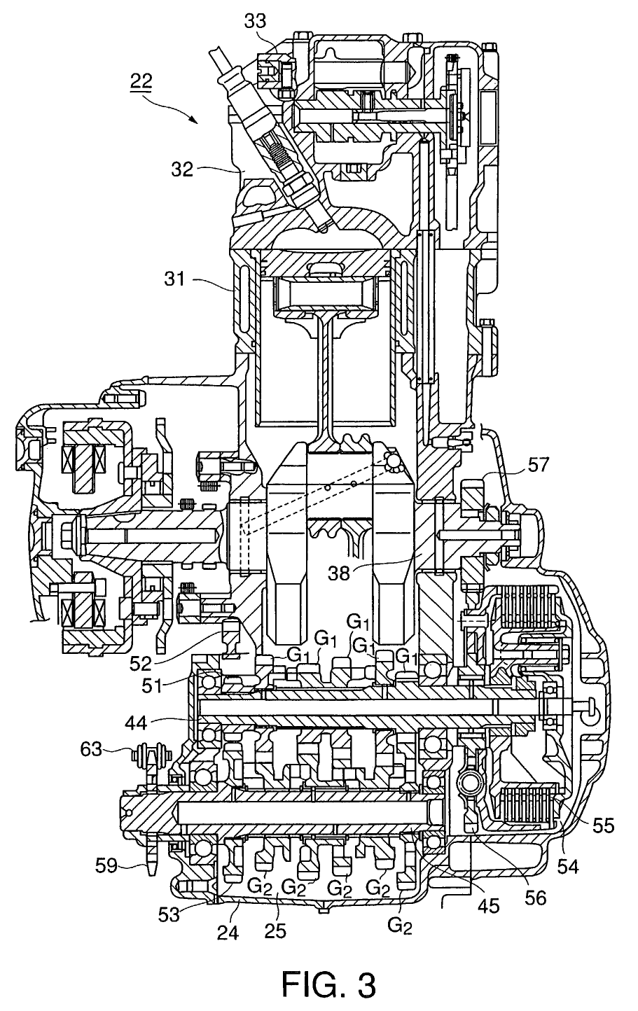

FIG. 3 is a cross sectional view of FIG. 2 taken along III-III line showing insides of the front cylinder 22 and the transmission chamber 25. In FIG. 3, the transmission 25 is of a constant-mesh-gear type, with five forward stages and one reverse stage. A forward input side transmission gear group Gi is fitted to the transmission input shaft 44, or spline-fitted thereto in an axially movable manner, and the forward input side transmission gear group G1 has transmission gears for one to five forward stages. A reverse input side transmission gear 51 is secured to a left end portion of the transmission input shaft 44. A right end portion of the transmission input shaft 44 projects inside a clutch chamber 54, and a clutch gear 56 and a multiple disc clutch 55 are attached to the projecting portion of the transmission input shaft 44. The clutch gear 56 is meshed with a crank gear 57 of the crank shaft 38.

A forward output side transmission gear group G2 has transmission gears, each of which is constantly meshed with the transmission gears of the forward input side transmission gear group G1. The forward output side transmission gear group G2 having the respective transmission gears is fitted to the transmission output shaft 45, or spline-fitted thereto in an axially movable manner. A reverse output side transmission gear 53 is secured to a left end portion of the transmission output shaft 45. The reverse output side transmission gear 53 is meshed with the reverse input side transmission gear 51 through a reverse idling gear 52. A left end portion of the transmission output shaft 45 projects outside the transmission chamber 25, and an output sprocket 59 for driving rear wheels is securely attached to the projecting portion of the output shaft 45.

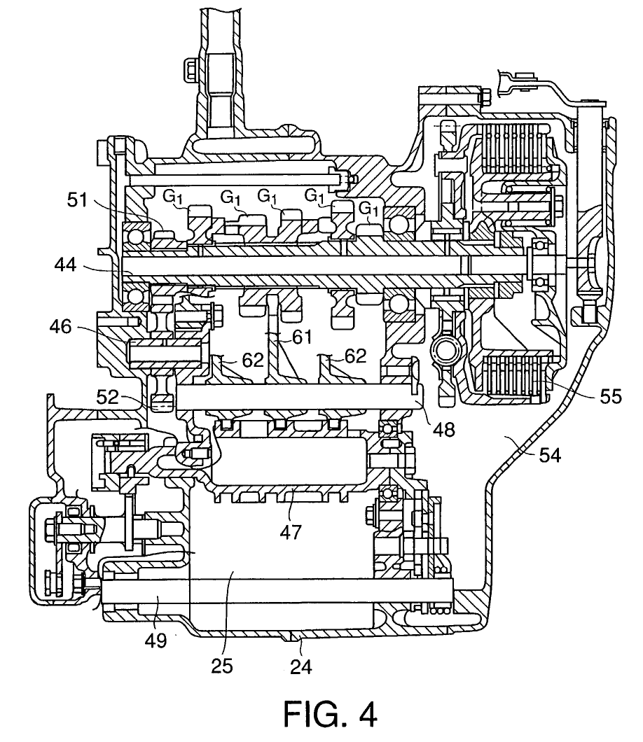

FIG. 4 is an expanded view of FIG. 2 taken along IV-IV line, which shows a shift arm 61 for the transmission input shaft 44 and two shift arms 62 for the transmission output shaft 45 being fitted in a shift rod 48 in an axially movable manner.

Driving pins of the respective arms 61 and 62 are engaged with shift grooves of the change drum 47. The change drum 47 is rotated to move the shift arms 61 and 62 in an axial direction so that a mesh between the transmission gear groups G1 and G2 can be changed to a desired transmission stage.

[Structure of Vehicle]

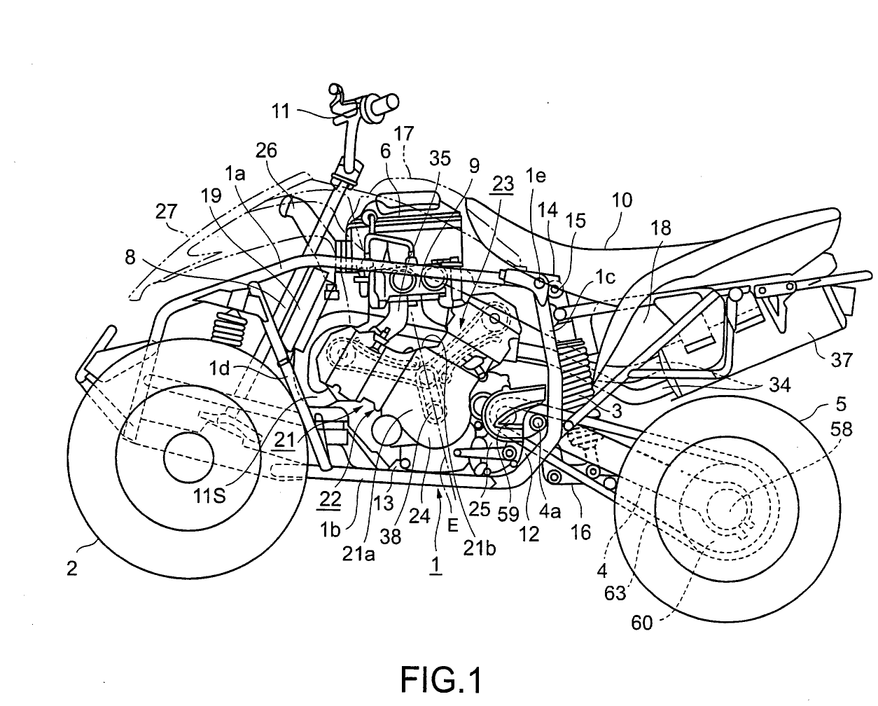

FIG. 1 is a left side cross-sectional view showing a first embodiment of a four-wheeled all terrain vehicle having the V-type engine 21 of FIG. 2 mounted thereon. The four-wheeled all terrain vehicle includes a body frame 1, a pair of right and left front wheels 2 suspended at a front end portion of the body frame 1, and a pair of right and left rear wheels 5 suspended at a rear portion of the body frame 1 through a swing arm 4. A front end portion 4a of the swing arm 4 is rotatably supported by an attachment bracket 12 of the body frame 1. The swing arm 4 is connected to a lower end portion of a rear suspension 3 through a link mechanism 16. A straddle-type seat 10 and a handle 11 of a bar shape are disposed above an upper portion of the body frame 1. The body frame 1 is provided with a steering shaft 8. The handle 11 is secured to an upper end portion of the steering shaft 8. The steering shaft 8 is positioned to be slightly inclined rearward.

The body frame 1 has a pair of frame structures disposed on right and left sides. Each frame structure has an upper frame member 1a, a lower frame member 1b, a rear frame member 1c, and a front frame member id located directly on a rear side of the front wheel 2, which are joined to each other by welding. The respective frame structures of the body frame 1 are integrally joined by means of a plurality of cross members. The front frame member 1d and the rear frame member 1c are approximately inclined forward, and the upper frame member 1a and the lower frame member 1b are approximately horizontally disposed. The four frame members 1a, 1b, 1c, and id form an engine-receiving space 11S between the front wheels 2 and the rear wheels 5, which is of a parallelogram shape inclined forward when viewed from a lateral side. The size and shape of the engine-receiving space 11S when viewed from a lateral side are substantially correspondent to a contour of the engine body 21a of the V-type engine 21 when viewed from a lateral side. The engine body 21a of the V-type engine 21 is installed in the engine receiving portion 11S without any part of the engine body 21a projecting therefrom.

The V-type engine 21 is installed in the engine-receiving space 11S of a parallelogram shape from a lateral side. A rear end portion of the crank case 24 and the front end portion 4a of the swing arm 4 are attached to the attachment bracket 12 of the rear frame member 1c. A front lower end portion of the crank case 24 is attached to an attachment bracket 13 of the lower frame member 1b.

The output sprocket 59 of the V-type engine 21 is connected to a sprocket 60 for a rear wheel through a rear wheel driving chain 63.

The exhaust pipe 34 of the front cylinder 22 is extended rearward to turn to the right side of the engine 21, and is connected to a common muffler 37 together with the exhaust pipe 34 of the rear cylinder 23.

An upper end portion of the rear suspension 3 is located at a rear upper corner of the engine-receiving space 11S of a parallelogram shape, and is rotatably supported by a cross member le through a bracket 14 and a connecting pin 15, the cross member le connecting both upper end portions of the right and left rear frame members 1c. The rear suspension 3 is inclined forward so that the rear suspension 3 extends substantially along the rear frame 1c when viewed from a lateral side. The rear suspension 3 is connected to the swing arm 4 through the link mechanism 16 as described above.

An air cleaner box 6 of the engine is disposed between the steering shaft 8 and the seat 10. The air cleaner box 6 is connected to an upper surface of the carburetor 9 and is covered with a cover 17 from above. The carburetor 9 is disposed in or above the V-bank 21b of the engine 21. An air intake duct 26 is connected to a front surface of the air cleaner box 6, and the air intake duct 26 extends forward and upward through a front fender 27 so that air can be taken through an air-taking hole formed in the front fender 27.

A radiator 19 is disposed above a front upper end portion of the engine-receiving space 11S of a parallelogram shape so that the radiator 19 is located between the steering shaft 8 and the front cylinder 22. The radiator 19 is attached to the body frame 1.

A fuel tank 18 is disposed between a rear side of the rear suspension 3 and a lower side of the seat 10.

As described above, the V-type engine 21 having the transmission mechanism 25 of a constant-mesh-gear type received in a rear portion of the crank case 24 is formed such that the center line E of the V-bank 21b is inclined forward. The body frame 1 has the engine-receiving space 11S of a parallelogram shape which can completely accommodate therein the engine body 21a of the engine 21 when viewed from a lateral side. An upper end portion of the rear suspension 3 is supported at a rear upper corner of the engine-receiving space 11S. Thus, the engine 21 can easily be attached to the body frame 1, and can also easily be maintained from a lateral side. Further, the objects mounted between the front and rear wheels 2 and 5 can be arranged in a compact manner, with a support rigidity of the rear suspension 3 being retained.

Since the radiator 19 is disposed between the steering shaft 8 and the front cylinder 22, a gravity point of the vehicle can be set to a center portion in the fore-and-aft direction.

The air cleaner box 6 is disposed above the carburetor 9, which is located on an upper side of the V-bank 21b, which makes it possible to efficiently take in a traveling wind from a front side by the short intake duct 26, for example.

Second Embodiment

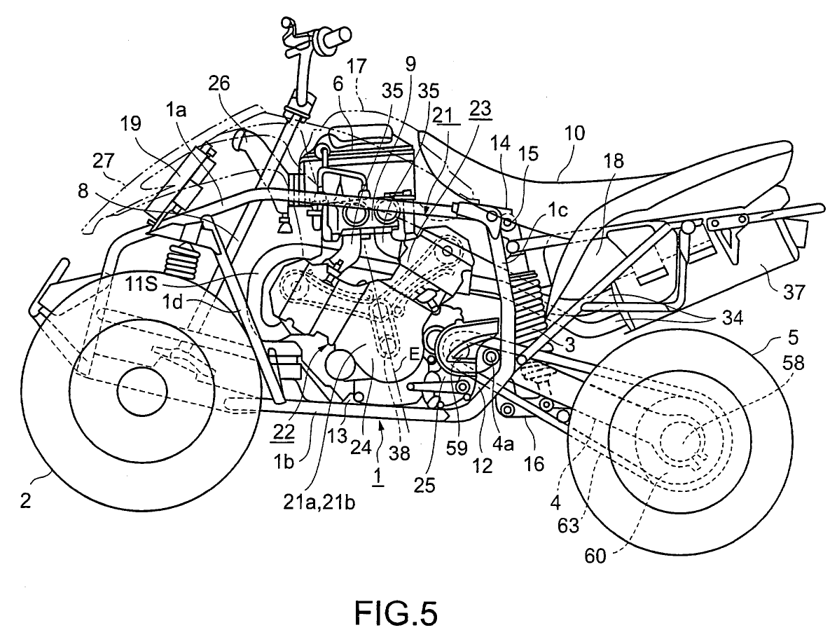

FIG. 5 shows a second embodiment of a four-wheeled all terrain vehicle according to the present invention. The second embodiment differs from the first embodiment in that the radiator 19 is disposed on a front side of the steering shaft 8 and in the front fender 27. Other constitutions of the second embodiment are the same as those of the first embodiment shown in FIG. 1, and the same parts as those of FIG. 1 have the same reference numbers. The engine mounted on the vehicle is naturally the same one which is described with reference to FIGS. 2 to 4.

As compared to the constitution shown in FIG. 1, the constitution shown in FIG. 5 can improve a cooling effect of the radiator 19.

Third Embodiment

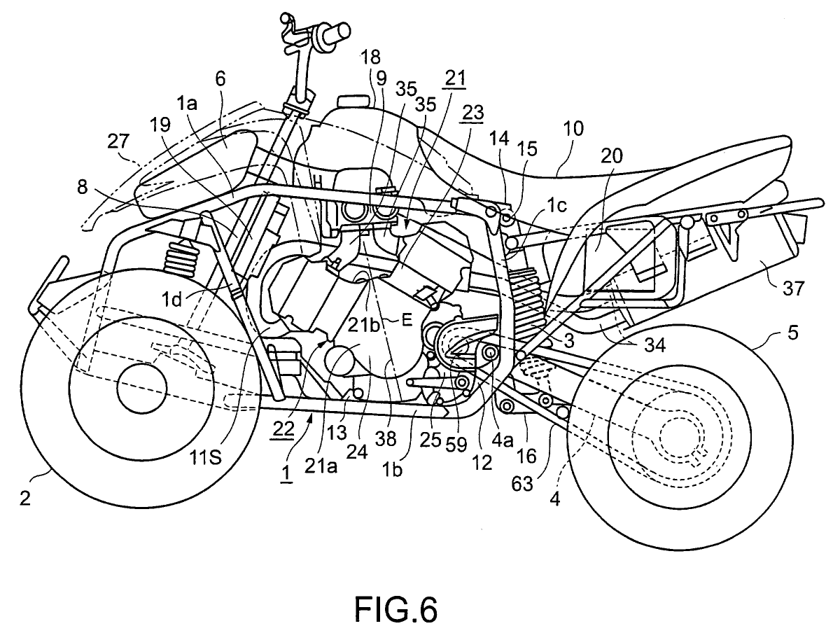

FIG. 6 shows a third embodiment of a four-wheeled all terrain vehicle according to the present invention. The third embodiment differs from the first embodiment in that the fuel tank 18 is disposed above the carburetor 9, that the air cleaner box 6 is disposed on a front side of the steering shaft 8 and in the front fender 27, and that the battery 20 is disposed on a rear side of the rear suspension 3 and on a lower side of the seat 10. Other constitutions of the third embodiment are the same as those of the first embodiment shown in FIG. 1, and the same parts as those of FIG. 1 have the same reference numbers. The engine 21 mounted on the vehicle is the same one which is described with reference to FIGS. 2 to 4.

As compared to the constitution shown in FIG. 1, the constitution shown in FIG. 6 can improve a weight balance of the body frame and an air-intake performance. That is to say, the fuel tank 18, a weight of which changes depending on an amount of a fuel, is disposed on an upper side of the engine 21, and therefore a weight balance of the body frame is less influenced by an amount of a fuel. The air cleaner box 6 is placed within the front fender 27 so that an air-intake performance can be improved.

Fourth Embodiment

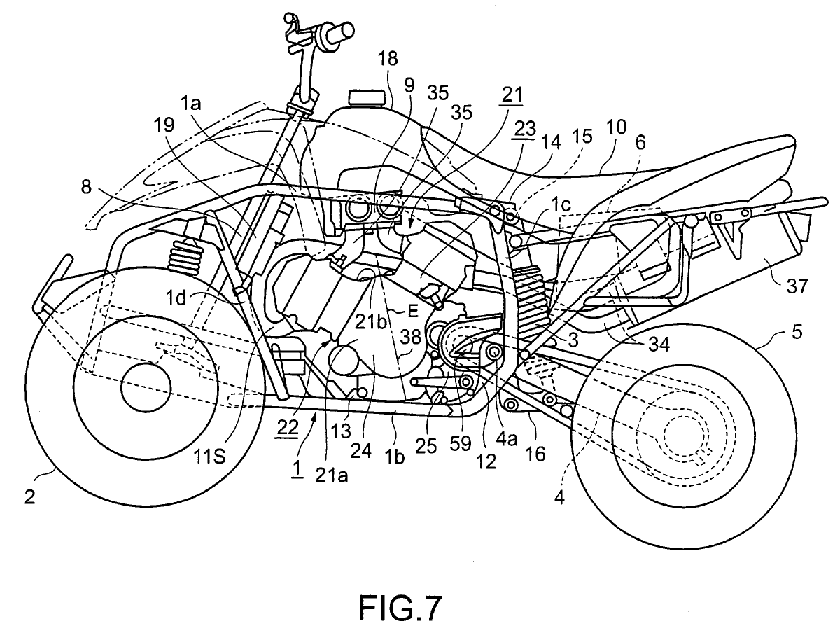

FIG. 7 shows a fourth embodiment of a four-wheeled all terrain vehicle according to the present invention. The fourth embodiment differs from the first embodiment in that the fuel tank 18 is disposed above the carburetor 9, and that the air cleaner box 6 is disposed on a rear side of the rear suspension 3 and on a lower side of the seat 10. Other constitutions of the third embodiment are the same as those of the first embodiment shown in FIG. 1, and the same parts as those of FIG. 1 have the same reference numbers. The engine 21 mounted on the vehicle is the same one which is described with reference to FIGS. 2 to 4.

As compared to the constitution shown in FIG. 1, the constitution shown in FIG. 7 can improve a weight balance of the body frame, and mud or water can be more prevented from entering the air cleaner box 6. That is to say, the fuel tank 18, a weight of which changes depending on an amount of a fuel, is disposed on an upper side of the engine, and therefore a weight balance of the body frame is less influenced by an amount of a fuel. The air cleaner box 6 is disposed on a rear side of the rear suspension 3 and on a lower side of the seat 10, and therefore mud or water can be prevented from entering the air cleaner box 6.

Fifth Embodiment

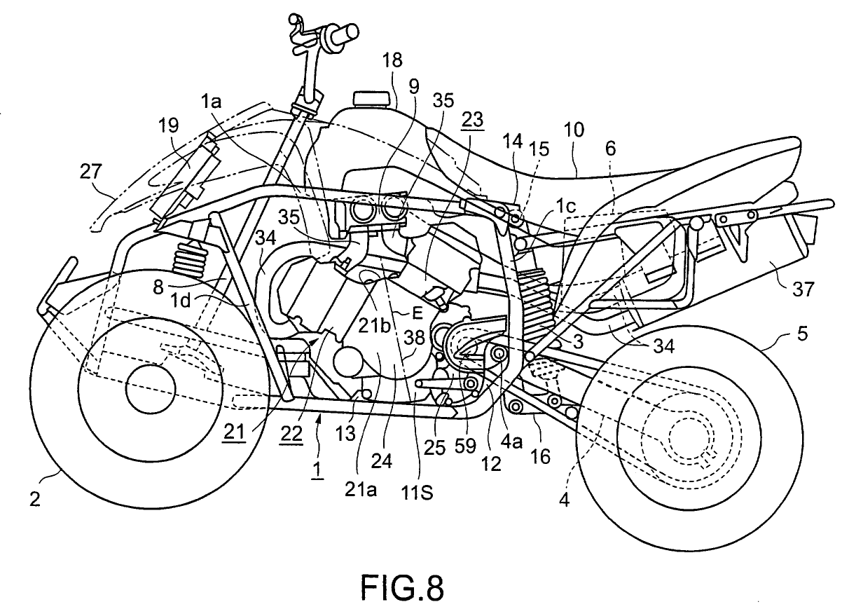

FIG. 8 shows a fifth embodiment of a four-wheeled all terrain vehicle according to the present invention. The fifth embodiment differs from the first embodiment in that the fuel tank 18 is disposed above the carburetor 9, that the air cleaner box 6 is disposed on a rear side of the rear suspension 3 and on a lower side of the seat 10, and that the radiator 19 is disposed on a front side of the steering shaft 8 and in the front fender 27. Other constitutions of the third embodiment are the same as those of the first embodiment shown in FIG. 1, and the same parts as those of FIG. 1 have the same reference numbers. The engine 21 mounted on the vehicle is the same one which is described with reference to FIGS. 2 to 4. The constitution shown in FIG. 8 and that shown in FIG. 7 are different only for a location of the radiator 19.

As compared to the constitution shown in FIG. 1, the constitution shown in FIG. 8 can improve a weight balance of the body frame, and mud or water can be more prevented from entering the air cleaner box 6, similar to that shown in FIG. 7. A cooling effect of the radiator can also be improved.

Other Embodiments

(1) The present invention may be applied to a V-type engine having a fuel injection system in place of the carburetor.

(2) In order to enhancing a rigidity of the body frame while easily attaching a V-type engine to the body frame, there may be disposed a reinforcing frame member diagonally crossing the engine-receiving space of the parallelogram shape so as to attach the V-type engine to the body frame by means of a bolt, for example.

(3) The present invention may be applied to a V-type engine having a fuel injection system disposed in the V-bank.

(4) The present invention may be applied to a four-wheeled all terrain vehicle in which an engine output is transmitted to an input shaft of a gear type transmission mechanism through a belt continuously variable transmission.

Although the invention has been described in its preferred embodiment with a certain degree of particularity, obviously many changes and variation are possible therein. It is therefore to be understood that the present invention may be practiced otherwise than as specifically described herein without departing from the scope and spirit thereof.

1. A four-wheeled all terrain vehicle comprising:
a body frame forming an engine-receiving space of a parallelogram shape inclined forward when viewed from a lateral side;
a V-type engine including an engine body and a carburetor or a fuel injection system, the engine body comprising a front cylinder inclined forward, a rear cylinder inclined rearward, and a crank case having a transmission chamber in a rear portion thereof for containing a transmission mechanism, the engine body being formed such that a center line of a V-bank formed between the front cylinder and the rear cylinder is inclined forward, the carburetor or the fuel injection system being disposed in or above the V-bank of the engine body;
front wheels and rear wheels which are suspended by the body frame;
a straddle-type seat held by an upper portion of the body frame; and
a rear suspension for supporting rear wheels, an upper end of the rear suspension being held at a rear upper corner of the engine receiving space of the body frame; wherein
the engine body of the V-type engine is installed in the engine-receiving space of the body frame substantially without the engine body protruding therefrom.

2. A four-wheeled all terrain vehicle according to claim 1, wherein
an air cleaner box of the engine is disposed above the carburetor or the fuel injection system, and a fuel tank of the engine is disposed on a rear side of the rear suspension and a lower side of the seat.

3. A four-wheeled all terrain vehicle according to claim 1, wherein
a fuel tank of the engine is disposed above the carburetor or the fuel injection system.

4. A four-wheeled all terrain vehicle according to claim 3, wherein
a steering shaft of the vehicle is disposed on a front side of the body frame, and wherein
the air cleaner box is disposed in a front fender of the vehicle disposed on a front side of the steering shaft.

5. A four-wheeled all terrain vehicle according to claim 4, wherein
a battery of the vehicle is disposed on a rear side of the rear suspension.

6. A four-wheeled all terrain vehicle according to claim 3, wherein
an air cleaner box of the engine is disposed on a rear side of the rear suspension and a lower side of the seat.

7. A four-wheeled all terrain vehicle according to claim 1, wherein
a steering shaft of the vehicle is disposed on a front side of the body frame, and a radiator of the engine is disposed between the front cylinder of the V-type engine and the steering shaft.

8. A four-wheeled all terrain vehicle according to claim 1, wherein
a steering shaft of the vehicle is disposed on a front side of the body frame, and a radiator of the engine is disposed in a front fender of the vehicle disposed on a front side of the steering shaft.
